(19) United States
(12) Patent Application Publication
(10) Pub. No.: US 2015/0350159 A1
(43) Pub. Date: Dec. 3, 2015

(54) EFFICIENT COMMUNICATIONS THROUGH A SHARED COMMUNICATION MEDIUM

(71) Applicant: QUALCOMM Incorporated, San Diego, CA (US)

(72) Inventors: Lochan Verma, San Diego, CA (US); Xiaodong Wang, San Diego, CA (US); Mu-Huan Chiang, San Diego, CA (US); Vijayalakshmi Rajasundaram Raveendran, San Diego, CA (US)

(21) Appl. No.: 14/715,402

(22) Filed: May 18, 2015

Related U.S. Application Data
(60) Provisional application No. 62/005,626, filed on May 30, 2014.

(51) Int. Cl. H04L 29/12; H04L 12/26; H04B 5/00

(52) U.S. Cl. CPC H04L 61/6022; H04B 5/0031; H04L 43/0888

(57) ABSTRACT

A method and apparatus are disclosed for transferring data through a shared communication medium between communication devices. In at least one embodiment, a timeout period used to detect data transfer errors may be modified based, at least in part, on a data transfer status message transmitted from a media access control (MAC) layer to a protocol adaptation layer of a first communication device. The data transfer status message may include a status and an expected duration of a pending data transfer. In another embodiment, The timeout period may be modified based, at least in part, on data transfer statistics transmitted from the MAC layer to the protocol adaptation layer. Data transfer statistics may be accumulated by the MAC layer and may include data transfer size, data throughput rates, and number of re-attempted data transfers.

### CROSS REFERENCE TO RELATED APPLICATIONS

This application is a non-provisional application claiming priority under 35 U.S.C. §119(e) to co-pending and commonly owned U.S. Provisional Application No. 62/005,626, filed May 30, 2014, the entirety of which is incorporated by reference herein.

### TECHNICAL FIELD

The example embodiments relate generally to network communications and specifically to communications through a shared communication medium.

### BACKGROUND OF RELATED ART

A communication network may include multiple communication devices. Some communication networks may use a shared communication medium through which the communication devices may transmit and receive data. Examples of shared communication mediums may include wired communication mediums (e.g., cable and/or wire-based mediums operating according to Ethernet and/or powerline communication protocols) and wireless communication mediums (e.g., mediums using transmitted and received radio frequency (RF) signals operating according to IEEE 802.11, BLUETOOTH® and/or other wireless specifications).

For some shared wireless communication mediums, the IEEE 802.11 standards define a distributed coordination function (DCF) that instructs individual communication devices to “listen” to the shared communication medium to determine when the shared communication medium is idle (e.g., using a “carrier sense” technique to determine when the shared communication medium is not being used). When a communication device detects that the shared communication medium has been continuously idle for a DCF Interframe Space (DIFS) duration, the communication device may attempt to transmit (e.g., transfer) data on the shared communication medium. To prevent multiple communication devices from accessing the shared communication medium at the same time, each communication device may select a random “back-off” number or period. At the end of the DIFS duration, a medium access contention period begins during which each communication device waits for a period of time determined by its back-off number (e.g., its back-off period) before it attempts to transmit data on the shared communication medium. The communication device that selects the lowest back-off number has the shortest back-off period, and therefore “wins” the medium access contention operation. The winning communication device may be granted access to the shared communication medium for a period of time commonly referred to as the transmit opportunity (TXOP).

Sometimes, a communication device may make several unsuccessful attempts to transmit data during its TXOP. An event timer, such as a transfer timer, may be used to determine if the attempted data transfers are not completed within a timeout period. If the timeout period is exceeded, than an error recovery procedure begins. The error recovery procedure may include resetting the transfer timer and retrying the data transfer.

In some cases, the timeout period may be set to a value that may allow multiple data transfer retries to be attempted before the timeout period expires. However, relying on the transfer timer to detect failed data transfers may result in an inefficient detection of error conditions. As a result, the communication device's throughput and/or the shared communication medium's bandwidth may be unnecessarily reduced.

Thus, there is a need to improve the detection of error conditions during a data transfer and thereby improve access to the shared communication medium.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus for managing data transfers from a first communication device are disclosed. In accordance with some embodiments, the first communication device may include a protocol adaptation layer (PAL) unit and a media access control (MAC) layer unit. The PAL unit may initialize a transfer timer value indicative of a timeout period. The MAC layer unit may initiate a data transfer to a second communication device through a shared communication medium, where the data transfer is to be completed within the timeout period. The PAL unit may selectively modify the timeout period based, at least in part, on a status of a data transfer.

In some embodiments, to modify the timeout period, the PAL unit may receive the status message from the MAC layer unit indicating the status of the data transfer. The PAL unit may extend the timeout period if the status of the data transfer indicates a data transfer in progress, or the PAL unit may cancel the data transfer if the status of the data transfer indicates a failed data transfer.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 depicts an example system within which the example embodiments may be implemented.

FIG. 2 shows a simplified block diagram depicting communication devices configured to transfer data through a shared communication medium, in accordance with example embodiments.

FIG. 3 shows a message diagram illustrating messages and delays that may occur during a data transfer between a transmitting communication device and a receiving communication device, in accordance with example embodiments.

FIG. 4 shows a message diagram illustrating data transfer status messages that may be exchanged between a protocol adaptation layer unit and media access control layer unit of FIG. 2, in accordance with example embodiments.

FIG. 5 shows a message diagram illustrating additional data transfer status messages that may be exchanged between the protocol adaptation layer unit and the media access control layer unit of FIG. 2, in accordance with example embodiments.

FIG. 6 shows a communication device that is another embodiment of at least one of the communication devices of FIG. 1.

FIG. 7 shows an illustrative flow chart depicting an example operation for transferring data through a shared communication medium, in accordance with example embodiments.

FIG. 8 shows an illustrative flow chart depicting another example operation for transferring data through a shared communication medium by a communication device, in accordance with example embodiments.

### DETAILED DESCRIPTION

The example embodiments are described below in the context of Wi-Fi enabled devices for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “wireless local area network (WLAN)” and “Wi-Fi” may include communications governed by the IEEE 802.11 standards, BLUETOOTH®, HiperLAN (a set of wireless standards, comparable to the IEEE 802.11 standards, used primarily in Europe), and other technologies used in wireless communications. Thus, the terms “WLAN” and “Wi-Fi” may be used interchangeably herein. In addition, the example embodiments described herein may be implemented within infrastructure WLAN systems including one or more APs and a number of STAs, within multiple WLANs, within peer-to-peer (or Independent Basic Service Set) systems, within Wi-Fi Direct systems, and/or within Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scope all embodiments defined by the appended claims.

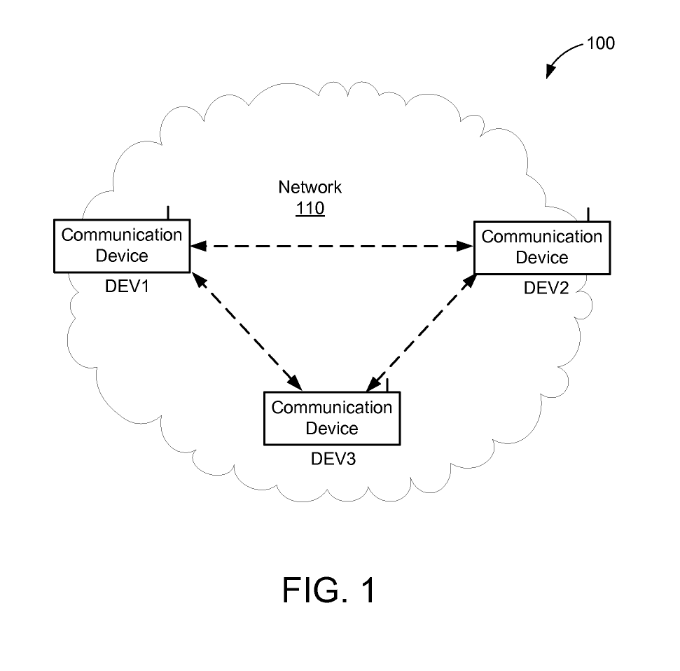

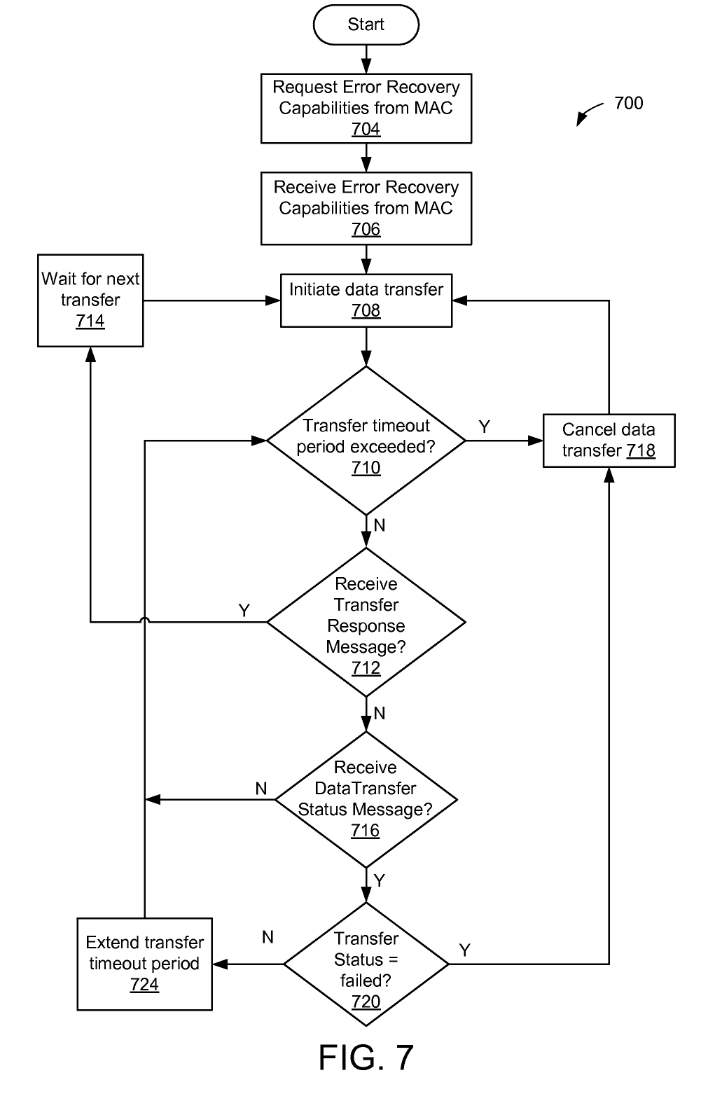

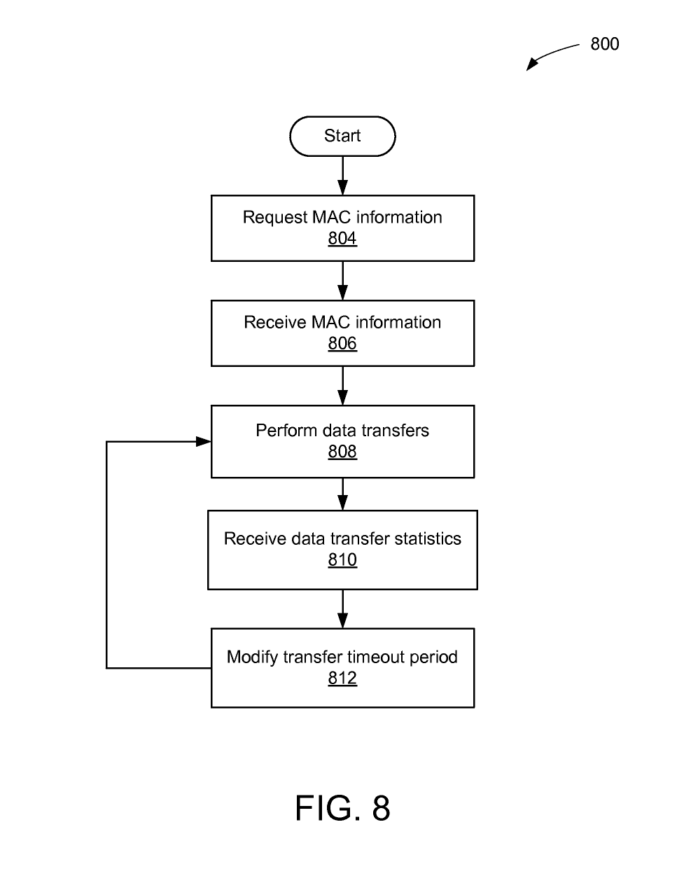

FIG. 1 depicts an example system 100 within which the example embodiments may be implemented. The system 100 may include three communication devices DEV1-DEV3 that operate within a network 110. Although only three communication devices are shown in FIG. 1 for simplicity, it is to be understood that the system 100 may include any number of communication devices. Each of the communication devices DEV1-DEV3 may be any suitable Wi-Fi enabled wireless device including, for example, a cell phone, personal digital assistant (PDA), tablet device, laptop computer, or the like. Each of the communication devices DEV1-DEV3 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a mobile station (STA), a client, or some other suitable terminology. For at least some embodiments, each of the communication devices DEV1-DEV3 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 7-8.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

Data may be transferred between communication devices DEV1-DEV3 through a shared communication medium used by the network 110. For some embodiments, the shared communication medium may be a wireless medium through which the communication devices DEV1-DEV3 may transfer data wirelessly. For other embodiments, the shared communication medium may be a wired medium (e.g., twisted pair, co-axial cable, fiber) through which the communication devices DEV1-DEV3 may transfer data (e.g., according to Ethernet standards, powerline communications (PLC) standards, or any other technically feasible wired communication standard or protocol).

As mentioned above, a collision may occur when two or more of the communication devices DEV1-DEV3 attempt to access the shared communication medium at approximately the same time. When one or more of the communication devices DEV1-DEV3 detects the collision, the detecting communication device(s) waits for its randomly selected backoff period, and then re-attempts to access the shared communication medium. If the communication device does not successfully complete the data transfer within a predefined timeout period (e.g., as measured by a transfer timer), then a data transfer error may be detected. Waiting for the expiration of the timeout period may delay detection of data transfer errors which, in turn, may result in unnecessary idle time for the communication device and/or may reduce an effective bandwidth of the shared communication medium.

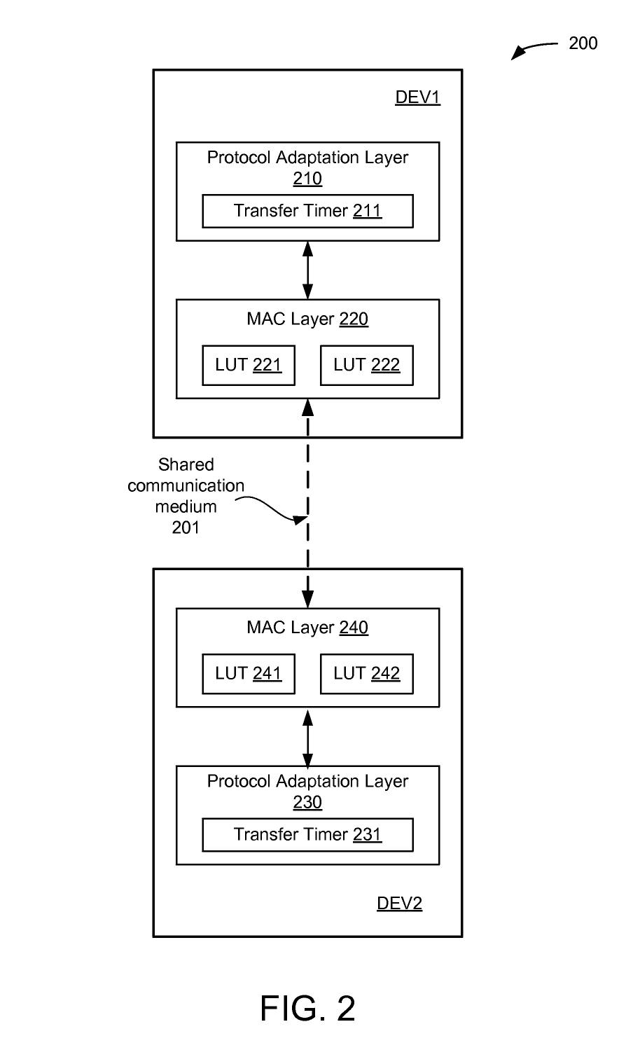

FIG. 2 shows a simplified block diagram 200 depicting communication devices configured to transfer data through a shared communication medium 201, in accordance with example embodiments. Although block diagram 200 only shows two communication devices DEV1 and DEV2, system 100 may include any number of communication devices. Furthermore, although block diagram 200 only depicts a data transfer between two communication devices DEV1 and DEV2 (e.g., a unicast data transfer), in other embodiments, data may be transferred between three or more communication devices (e.g., a multicast and/or broadcast data transfer).

Communication device DEV1 may include at least a protocol adaptation layer (PAL) unit 210 and a media access control (MAC) layer unit 220. PAL unit 210 may provide an interface for programs and/or routines running within communication device DEV1 wanting access to the shared communication medium 201. For example, a data transfer request may be received by PAL unit 210 from an application program running within communication device DEV1. In some embodiments, the data transfer request may be in accordance with one or more communication protocols. The data transfer request may, in turn, be sent to MAC layer unit 220, which is coupled to PAL unit 210. For the example of FIG. 2, the PAL unit 210 may include a transfer timer 211 that, as described in more detail below, may be used to detect data transfer errors (e.g., data transfers that are not complete within a given duration of time, for example, as determined by a count value of transfer timer 211).

MAC layer unit 220 (which may include physical (PHY) layer components or may be coupled to a PHY layer device, not shown in FIG. 2 for simplicity) may connect communication device DEV1 to communication device DEV2 through the shared communication medium 201. Thus, MAC layer unit 220 may initiate a connection with other communication devices in response to the data transfer request from PAL unit 210. In some embodiments, MAC layer unit 220 may make several attempts to access the shared communication medium 201. After access to the shared communication medium 201 is successful, a connection to communication device DEV2 may be made and data may be transferred via the shared communication medium 201. When the data transfer is successful, MAC layer unit 220 may send a transfer response message to PAL unit 210 to indicate a completed data transfer.

MAC layer unit 220 may include a first look-up table (LUT) 221 and a second LUT 222. The first LUT 221 may store one or more average back-off time values associated with various numbers of data transfer retry attempts (e.g., as described below with respect to Table 3). The second LUT 222 may store data channel delay times associated with various numbers of data transfer retry attempts and/or various numbers of successful data transfers (e.g., as described below with respect to Table 4).

In a similar manner, communication device DEV2 may include a MAC layer unit 240 and a PAL unit 230 that may be substantially similar to MAC layer unit 220 and PAL unit 210, respectively, of communication device DEV1. Thus, transferred data may be received by MAC layer unit 240 of communication device DEV2 from MAC layer unit 220 of communication device DEV1. MAC layer unit 240 may send the received data to PAL unit 230 of communication device DEV2. The MAC layer unit 240 may include a first LUT 241 and a second LUT 242, which for some embodiments may be similar to the first LUT 221 and the second LUT 222, respectively, of communication device DEV1. Further, PAL unit 230 may include a transfer timer 231, which for some embodiments may be similar to transfer timer 211 of communication device DEV1.

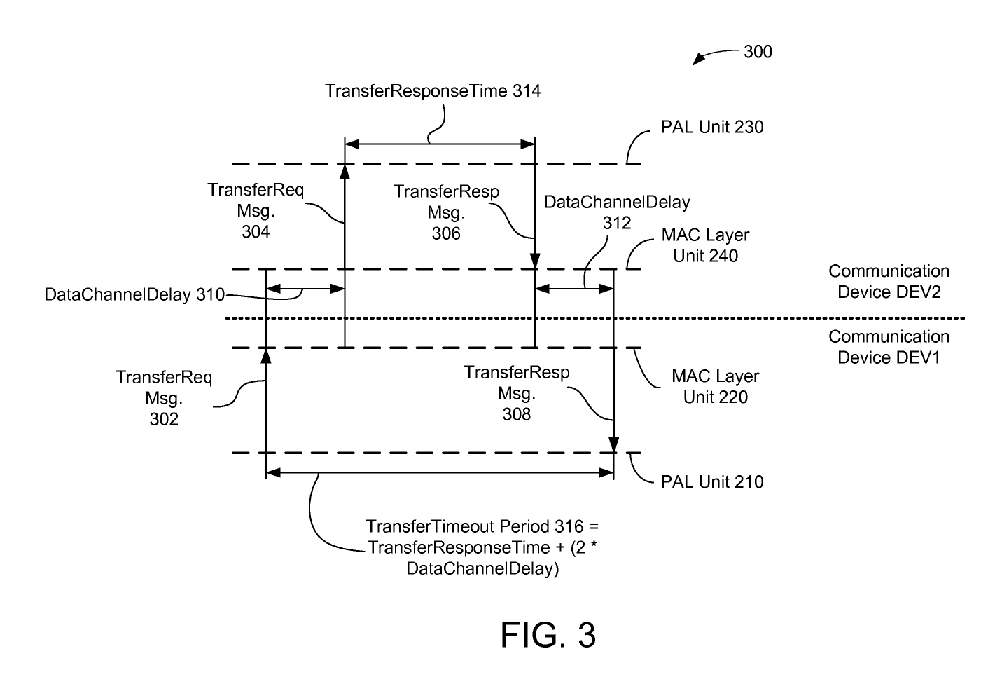

FIG. 3 shows a message diagram 300 illustrating messages and delays that may occur during a data transfer between a transmitting communication device and a receiving communication device, in accordance with example embodiments. For purposes of discussion herein, communication device DEV1 may be the transmitting communication device, and communication device DEV2 may be the receiving communication device. In other embodiments, other communication devices may be the transmitting and receiving communication devices.

Referring also to FIG. 2, when the data transfer begins, a TransferReq message 302 may be sent from PAL unit 210 to MAC layer unit 220 of communication device DEV1. TransferReq message 302 may cause MAC layer unit 220 to access the shared communication medium 201 and attempt to transmit data from communication device DEV1 to communication device DEV2. After a first DataChannelDelay 310 time period (e.g., indicative of access and transit time through the shared communication medium), a TransferReq message 304 may sent from MAC layer unit 240 to PAL unit 230 of communication device DEV2. In some embodiments, the TransferReq message 304 received at PAL unit 230 may include the data received from communication device DEV1.

Following a TransferResponseTime 314 time period, PAL unit 230 may send a TransferResp message 306 to MAC layer unit 240 of the receiving communication device DEV2. In some embodiments, the TransferResp message 306 may acknowledge reception of data from communication device DEV1. After a second DataChannelDelay 312 time period (which may be similar to first DataChannelDelay 310), MAC layer unit 220 may send a TransferResp message 308 to PAL unit 210 of communication device DEV1. TransferResp message 308 may serve as an acknowledgement message to communication device DEV1 to indicate that the data transfer has completed. In one embodiment, TransferReq messages 302 and 304 and/or TransferResp messages 306 and 308 may be primitive messages described in a Media Agnostic Universal Serial Bus specification associated with the IEEE 802.11 family of standards.

An upper limit for a TransferTimeout period 316 (e.g., the predefined timeout period) for the transfer timer may be determined based on TransferResponseTime and DataChannelDelay as expressed below in eq. 1:

TransferTimeout period=TransferResponseTime+(2*DataChannelDelay) (eq. 1)

The value of transfer timer 211 may be maintained by PAL unit 210 of communication device DEV1, and the value of transfer timer 231 may be maintained by PAL unit 230 of communication device DEV2. For some implementations, if a data transfer takes longer than TransferTimeout period 316 to complete, then PAL unit 210 may detect this error condition (e.g., a data transfer error), and terminate one or more pending data transfers. PAL unit 210 may cause MAC layer unit 220 to re-attempt (retry) the one or more pending data transfers.

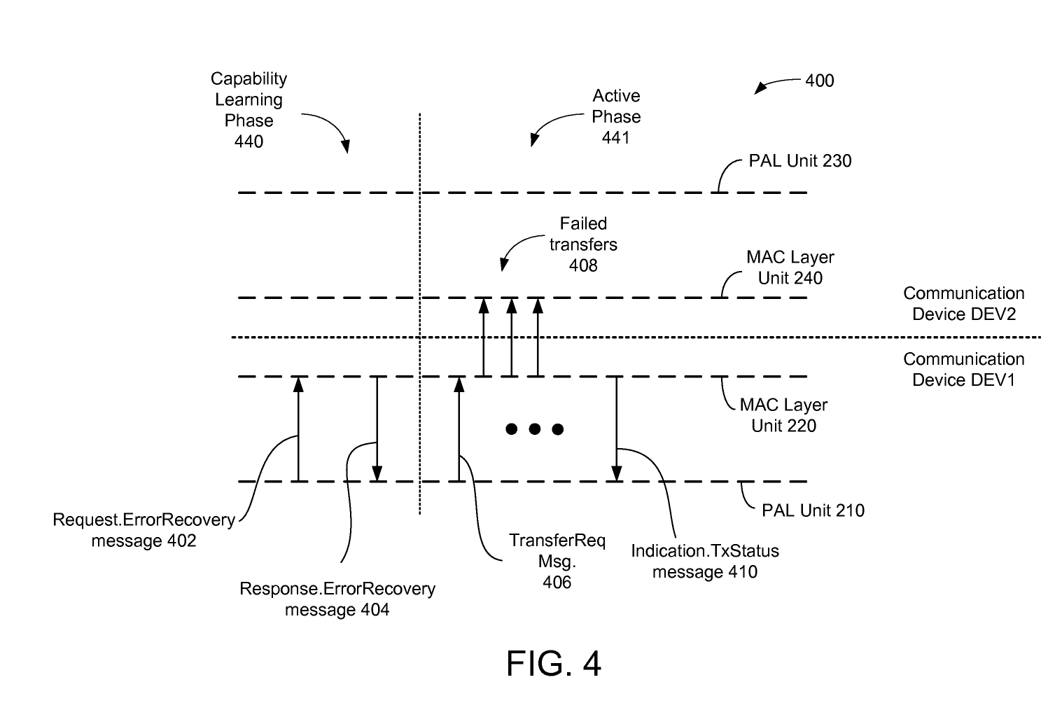

Under some conditions, communication device DEV1 may be idle while the PAL unit 210 waits for the value of transfer timer 211 to exceed TransferTimeout period 316 (which may indicate a data transfer error). For example, if MAC layer unit 220 supports relatively high data rates (e.g., data rates greater than a threshold value), then a maximum number of data transfers may be attempted before the transfer timer value exceeds TransferTimeout period 316. As a result, the shared communication medium 201 and/or communication device DEV1 may be idle until the transfer timer value exceeds TransferTimeout period 316. In another example, if MAC layer unit 220 supports a relatively low data rate (e.g., a data rate less than the threshold value), then the time needed to complete a transfer data may exceed TransferTimeout period 316 before the data transfer is completed. Thus, prematurely terminating the pending data transfer may delay a successful data transfer. Transmitting data transfer status messages between PAL unit 210 and MAC layer unit 220 of communication device DEV1 may help increase the efficiency of transferring data between communication devices by detecting error conditions and/or modifying TransferTimeout period 316 based on one or more operating conditions. Data transfer status messages are described in more detail below in conjunction with FIGS. 4-8.

FIG. 4 shows a message diagram 400 illustrating data transfer status messages that may be exchanged between PAL unit 210 and MAC layer unit 220 of communication device DEV1, in accordance with example embodiments. In some embodiments, some data transfer status messages may be exchanged prior to data transfers during a capability learning phase 440, and additional data transfer status messages may be exchanged during an active phase 441 during pending data transfers.

During capability learning phase 440, PAL unit 210 may determine error recovery capabilities of MAC layer unit 220. In some embodiments, PAL unit 210 may send a Request.ErrorRecovery message 402 to MAC layer unit 220. Request.ErrorRecovery message 402 may operate as a request for MAC layer unit 220 to reply with associated error recovery capabilities (e.g., Request.ErrorRecovery message 402 may be an error recovery capability request message). In some embodiments, Request.ErrorRecovery message 402 may include error recovery information associated with PAL unit 210. For example, Request.ErrorRecovery message 402 may include TransferTimeout period 316 which, in some embodiments, may be expressed in milliseconds (ms).

In response to receiving Request.ErrorRecovery message 402, the MAC layer unit 220 may send a Response.ErrorRecovery message 404 to the PAL unit 210. Response.ErrorRecovery message 404 may provide error recovery capability information to the PAL unit 210 (e.g., Response.ErrorRecovery message 404 may be an error recovery capability message). In some embodiments, the Response.ErrorRecovery message 404 may include information indicating whether error recovery procedures are supported by the MAC layer unit 220. For example, Response.ErrorRecovery message 404 may indicate that error recovery procedures are supported and other data transfer status messages may be sent during a pending data transmission (e.g., during active phase 441). In some embodiments, the Response.ErrorRecovery message 404 may also include a maximum number of data transfer attempts that may be provided by the MAC layer unit 220.

During active phase 441, a data transfer between communication devices DEV1 and DEV2 may begin when PAL unit 210 sends a TransferReq message 406 to MAC layer unit 220 within communication device DEV1. In some embodiments, TransferReq message 406 may be another embodiment of TransferReq message 302. When a data transfer begins, the transfer timer 211 may be started. Attempts by MAC layer unit 220 to access the shared communication medium may fail, for example, as shown by failed transfers 408. MAC layer unit 220 may send an Indication.TxStatus message 410 to PAL unit 210 before expiration of the transfer timer. Indication.TxStatus message 410 may be a data transfer status message to provide status information regarding the pending data transfer. Indication.TxStatus message 410 may include a status field to store a TxStatus value that indicates a status of the pending data transfer. For example, the TxStatus value may indicate a failed data transfer or may indicate that a data transfer is in progress. TxStatus values in accordance with example embodiments are shown below in Table 1:

TABLE 1

| TxStatus | Description |
|---|---|
| TX_FAIL | All (re)transmissions have failed (i.e., |
| | no acknowledgement has been |
| | received from receiving |
| | communication device |
| TX_IN_PROGRESS | The (re)transmission is in progress |

In some embodiments, Indication.TxStatus message 410 may include an expected duration field to store an expected duration of the pending data transfer. For example, the expected duration may indicate a time period (e.g., milliseconds (ms)) for the MAC layer unit 220 to complete the pending data transfer to communication device DEV2. An expected duration field for Indication.TxStatus message 410 in accordance with example embodiments is shown below in Table 2:

TABLE 2

| Field | Value | Description |
|---|---|---|
| Expected duration for | Time in milliseconds | MAC layer unit 220 |
| pending data | | estimate of time required |
| (re)transmission | | to finish the data |
| | | (re)transmission |

For example, MAC layer unit 220 may estimate an expected data transmission time (e.g., an expected duration for a pending data transfer) based at least in part on an amount of data to be transmitted and/or a determined modulation coding scheme (MCS) (which may determine a data throughput rate). In some embodiments, Request.ErrorRecovery message 402, Response.ErrorRecovery message 404, and/or Indication.TxStatus message 410 may be primitive messages exchanged between the PAL unit 210 and the MAC layer unit 220.

As described above, the transfer timer 211 may be used to determine when a data transfer error occurs. For example, if a pending data transfer does not complete within a TransferTimeout period 316 (e.g., if the transfer timer value >TransferTimeout period 316), then the pending data transfer may be terminated. The data transfer may be re-attempted and the transfer timer value may be reset.

In some embodiments, Indication.TxStatus message 410 may be used to modify TransferTimeout period 316. Modifying TransferTimeout period 316 may reduce idle time associated with the shared communication medium. For example, during a pending data transfer, PAL unit 210 may receive Indication.TxStatus message 410. The Indication.TxStatus message 410 may indicate that the pending data transfer is in progress and may include an expected duration of the pending data transfer.

TransferTimeout period 316 may be extended by an amount of time based, at least in part, on the expected duration of the pending data transfer. Extending the TransferTimeout period 316 may prevent premature termination (and subsequent retry) of a data transfer, for example, when a relatively slow data throughput rate is used. On the other hand, if the pending data transfer is indicated as a failure (e.g., TxStatus=TX_FAIL), then the pending data transfer may be terminated, the transfer timer may be reset, and the data transfer may be retried before the expiration of the transfer timer value. Extending TransferTimeout period 316 and controlling data transfers are described in more detail below in conjunction with FIG. 7.

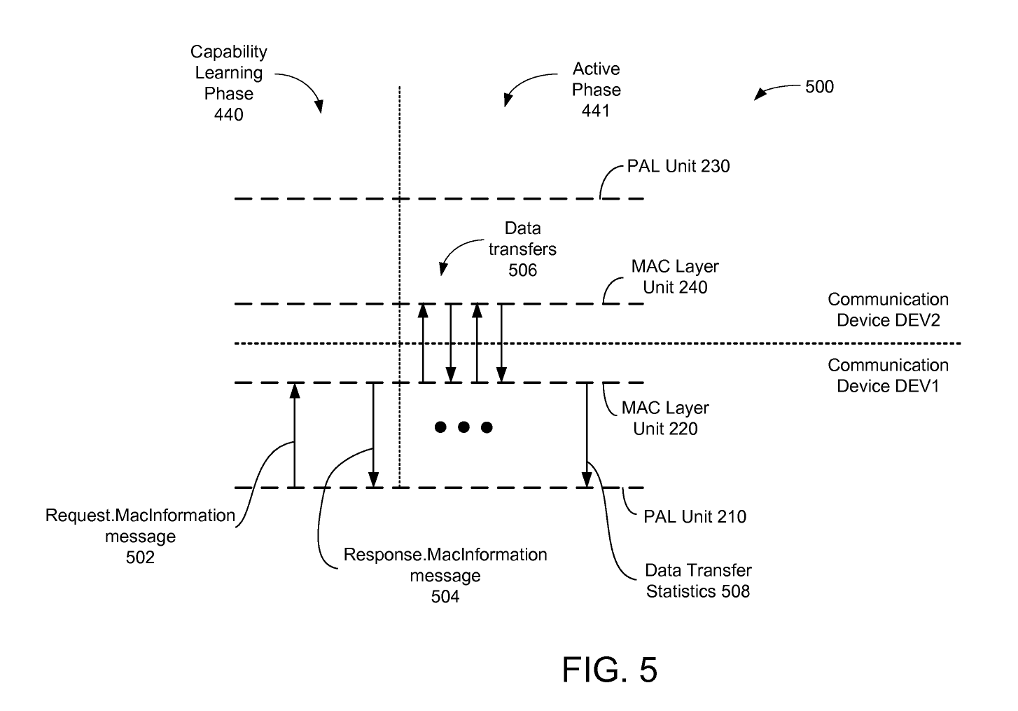

FIG. 5 shows a message diagram 500 illustrating additional data transfer status messages that may be exchanged between PAL unit 210 and MAC layer unit 220 of communication device DEV1, in accordance with example embodiments. In a similar manner as described above in conjunction with FIG. 4, some data transfer status messages may be exchanged between PAL unit 210 and MAC layer unit 220 of communication device DEV1 prior to requested data transfers during capability learning phase 440. For example, PAL unit 210 may send a Request.MacInformation message 502 to MAC layer unit 220. In response thereto, MAC layer unit 220 may send a Response.MacInformation message 504 to PAL unit 210. In some embodiments, Response.MacInformation message 504 may include:
MAC type: Indicates the type of MAC, such as 802.11a/b/g/n/ac/ad;
PHY transmission time overhead: indicates the transmission time in, e.g., microseconds (e.g., μs), for transmission of Physical Layer Convergence Protocol (PLCP) preamble and PLCP header;
Short Inter Frame Space (SIFS): indicates time in, (e.g., μs), of the inter frame spacing used by the MAC layer unit 220 during data transmission;
Slot time: indicates a length of a single time slot (e.g., timeslot length in μs) associated with a data transmission from MAC layer unit 220;
Number of data transfers (M): indicates the number of data transfers during which MAC layer unit 220 accumulates data transfer statistics (explained below); and
Contention Window: indicates minimum and maximum contention window times during which communication devices may content for access to the shared communication medium.

Data transfers between communication devices DEV1 and DEV2 may occur during active phase 441. In one embodiment, data transfers 506 may begin after PAL unit 210 sends a TransferReq message 302 (not shown for simplicity) to MAC layer unit 220. As data transfers proceed, MAC layer unit 220 may collect data transfer statistics such as, but not limited to, data transfer size (number of bytes transferred), MCS used for each data transfer (data throughput rate), and number of re-attempted data transfers (retries). Data transfer statistics may be collected for a predetermined number (M) of data transfers and/or attempted data transfers. The period during which the data transfer statistics are collected may be referred to as a MAC monitoring window.

Within communication device DEV1, MAC layer unit 220 may send data transfer statistics 508 to PAL unit 210. In some embodiments, data transfer statistics 508 may be grouped together and averaged based, at least in part, on data packet size. In some embodiments, data packet sizes may be divided into three groups: 1) data packet sizes less than 1500 bytes, 2) data packet sizes between 1500 and 4000 bytes, and 3) data packet sizes greater than 4000 bytes. For example, data transfer statistics 508 for data packets less than 1500 bytes may include an average MCS for the related data packets and the average number of retries. Data transfer statistics 508 for the other data packet sizes may be similarly grouped and determined. Other embodiments may use a different number (e.g., greater than or less than three) of groups, and/or each of the groups may be associated with any suitable range of data packet sizes.

PAL unit 210 may modify TransferTimeout period 316 based, at least in part, on data transfer statistics 508. In some embodiments, PAL unit 210 may calculate an updated first DataChannelDelay 310 and modify TransferTimeout period 316 in accordance with eq. 1. An example calculation for first DataChannelDelay 310 is expressed below in eq. 2:

DataChannelDelay=(t_{Phy}+t_{Mac})×n+Σᵢ₌₁ⁱ⁼ⁿt_{backoff} (eq. 2)

where:
t_{Phy}=t_{plcp}_{_{—}}_{preamble}+t_{plcp}_{_{—}}_{header}
t_{Mac}=t_{difs}+t_{data}+t_{ack}_{_{—}}ₜᵢₘₑₒᵤₜ
n is the number of (re)transmission attempts,
t_{difs}=t_{sifs}+2*tₛₗₒₜ, and
t_{ack}_{_{—}}ₜᵢₘₑₒᵤₜ=t_{sifs}+tₛₗₒₜ.
   In one embodiment, t_{Phy} may be a time associated with data transfer through a PHY layer of communication device DEV1, and may include a transmit time associated with a preample (t_{plcp}_{_{—}}_{preamble}) and/or a transmit time associated with a header (t_{plcp}_{_{—}}_{header}). In a similar manner, t_{Mac} may be a time associated with a data transfer through a MAC layer (e.g., MAC layer unit 220) and may include a DIFS time (t_{difs}), a time for data to be transmitted through the MAC layer (t_{data}) and/or a time associated with an acknowledgement timeout (t_{ack}_{_{—}}ₜᵢₘₑₒᵤₜ). Slot time (tₛₗₒₜ) may be based on a protocol implemented by PAL unit 210. The back-off time (t_{backoff}) time may be the time associated with the random back-off number or period of communication device DEV1.

The value of t_{backoff} may depend upon the sizes or durations of one or more contention windows associated with MAC layer unit 220. The PAL unit 210 may either calculate an average value of t_{backoff} using the formula shown above within eq. 2, or may retrieve the average back-off values (t_{backoff}) from the first LUT 221 (referring also to FIG. 2). More specifically, the first LUT 221 may store one or more average back-off values for each of a plurality of values of n. For some implementations, the first LUT 221 may be pre-configured (e.g., the one or more average back-off values for various numbers of data transfer retry attempts may be programmed in the first LUT 221 prior to operation of communication device DEV1, while for other implementations, the first LUT 221 may be dynamically populated with the average back-off values. An example population of the first LUT 221 is shown below in Table 3:

TABLE 3

| | (Re)Transmission | t_{backoff} |
|---|---|---|
| Retry Count | Count | (μs) |
| 0 | 1 | 40 |
| 1 | 2 | 80 |
| 2 | 3 | 160 |
| 3 | 4 | 320 |
| 4 | 5 | 640 |
| 5 | 6 | 1280 |
| 6 | 7 | 2560 |
| 7 | 8 | 2560 |
| 8 | 9 | 2560 |

In another embodiment, instead of calculating data channel delay values using eq. 2 above, PAL unit 210 may retrieve the data channel delay values from the second LUT 222. For some implementations, the second LUT 222 may be pre-configured (e.g., data channel delay values associated with the number of data transfer retry attempts and/or the number of data transfers may be programmed in the second LUT 222 prior to operation of communication device DEV1), while for other implementations, the second LUT 222 may be dynamically populated with data channel delay values associated with the number of data transfer retry attempts and/or the number of data transfers. An example population of the second LUT 222 is shown below in Table 4:

TABLE 4

| | (Re)Transmission | DataChannelDelay |
|---|---|---|
| Retry Count | Count | (μs) |
| 0 | 1 | 70.813 |
| 1 | 2 | 181.626 |
| 2 | 3 | 252.439 |
| 3 | 4 | 443.252 |
| 4 | 5 | 794.065 |
| 5 | 6 | 2488.878 |
| 6 | 7 | 2775.691 |
| 7 | 8 | 2806.504 |
| 8 | 9 | 2837.317 |

In some embodiments, the first LUT 221 described above with respect to Table 3 and/or the second LUT 222 described above with respect to Table 4 may be modified and/or updated as more or newer information regarding data transfers associated with MAC layer unit 220 becomes available. Extending a duration of TransferTimeout period 316 based on data transfer statistics 508 is described in more detail below in conjunction with FIG. 8.

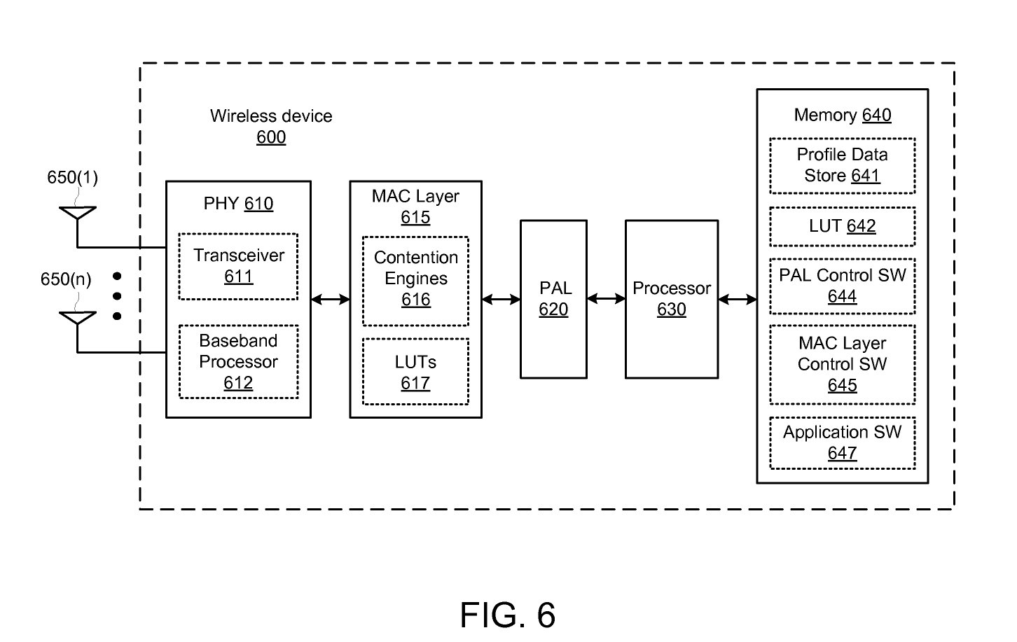

FIG. 6 shows a communication device 600 that is another embodiment of one or more of the communication devices DEV1-DEV3 of FIG. 1. The communication device 600 may include a PHY device 610 including at least a transceiver 611 and a baseband processor 612, may include a MAC layer unit 615 including at least a number of contention engines 616 and one or more LUTs 617, may include a PAL unit 620, may include a processor 630, may include a memory 640, and may include a number of antennas 650(1)-650(n). The transceiver 611 may be coupled to antennas 650(1)-650(n) either directly or through an antenna selection circuit (not shown for simplicity). The transceiver 611 may be used to transmit signals to and receive signals from other wireless devices, and may be used to scan the surrounding environment to detect and identify other nearby wireless devices. Although not shown in FIG. 6 for simplicity, the transceiver 611 may include any number of transmit chains to process and transmit signals to other wireless devices via antennas 650(1)-650(n), and may include any number of receive chains to process signals received from antennas 650(1)-650(n). Thus, for example embodiments, the communication device 600 may be configured for multiple-input, multiple-output (MIMO) operations. The MIMO operations may include single-user MIMO (SU-MIMO) operations and multi-user MIMO (MU-MIMO) operations.

The baseband processor 612 may be used to process signals received from processor 630 and/or memory 640 and to forward the processed signals to transceiver 611 for transmission via one or more of antennas 650(1)-650(n), and may be used to process signals received from one or more of antennas 650(1)-650(n) via transceiver 611 and to forward the processed signals to processor 630 and/or memory 640. Further, although not shown in FIG. 6 for simplicity, communication device 600 may also exchange data with other communication devices using one or more wired communication protocols via one or more wired mediums.

Referring also to FIG. 2, MAC layer unit 615 may be one embodiment of MAC layer unit 220 of communication device DEV1 and/or MAC layer unit 240 of communication device DEV2. The contention engines 616 may contend for access to one more shared communication mediums, and may also store packets for transmission over the one more shared communication mediums. For other embodiments, the contention engines 616 may be separate from MAC layer unit 615. For still other embodiments, the contention engines 616 may be implemented as one or more software modules (e.g., stored in memory 640 or stored in memory provided within MAC layer unit 615) containing instructions that, when executed by processor 630, perform the functions of contention engines 616.

The one or more LUTs 617 may be one embodiment of the first LUT 221 and the second LUT 222 of communication device DEV1, and/or may be one embodiment of the first LUT 241 and the second LUT 242 of communication device DEV2. Thus, as described in more detail below with respect to FIG. 8, the one or more LUTs 617 may store one or more average back-off time values associated with various numbers of data transfer retry attempts (e.g., as described above with respect to Table 3), and/or may store data channel delay times associated with various numbers of data transfer retry attempts and/or various numbers of successful data transfers (e.g., as described above with respect to Table 4).

PAL unit 620 may be one embodiment of PAL unit 210 of communication device DEV1 and/or PAL unit 230 of communication device DEV2. The PAL unit 620 may provide one or more instances of application software module 647 (described below) with access to other communication devices through the MAC layer unit 615. For example, multiple instances of the application software module 647 may transfer data to and from other communication devices via PAL unit 620. For at least one embodiment, data may be transferred between PAL unit 620 and MAC layer unit 615 according to a universal serial bus (USB) protocol, such as a Media Agnostic USB protocol described by IEEE 802.11 ad. For other embodiments, PAL unit 620 and MAC layer unit 615 may exchange data using any suitable medium and/or any suitable communication protocol.

For purposes of discussion herein, MAC layer unit 615 is shown in FIG. 6 as being coupled between PHY device 610 and PAL unit 620. For actual embodiments, PHY device 610, MAC layer unit 615, PAL unit 620, processor 630, and/or memory 640 may be connected together using one or more buses (not shown for simplicity).

Memory 640 may include a device profile data store 641 that stores profile information for a plurality of other communication devices. For example, the profile information for a particular communication device may include information including, for example, the communication device's MAC address, channel information, Received Signal Strength Indication (RSSI) values, supported data rates, supported error detection and recovery capabilities, MIMO configurations, and any other suitable information pertaining to or describing operations of the particular communication device.

Memory 640 may include one or more LUTs 642. In some embodiments, the one or more LUTs 642 may be one embodiment of LUTs 221-222 of communication device DEV1 and/or may be one embodiment of LUTs 241-242 of communication device DEV2. In other embodiments, the one or more LUTs 642 may be one embodiment of the one or more LUTs 617 of MAC layer unit 615.

The memory 640 may also include a non-transitory computer-readable storage medium (e.g., one or more nonvolatile memory elements, such as EPROM, EEPROM, Flash memory, a hard drive, etc.) that may store the following software modules:
a PAL control software module 644 to control PAL unit 620;
a MAC layer control software module 645 to control MAC layer unit 615; and
an application software module 647 to transmit data to and receive data from other communication devices.

Each software module includes program instructions that, when executed by processor 630, may cause communication device 600 to perform the corresponding function(s). Thus, the non-transitory computer-readable storage medium of memory 640 may include instructions for performing all or a portion of the operations of FIGS. 7 and/or 8.

Processor 630, which is coupled to PAL unit 620 and memory 640, may be any one or more suitable processors capable of executing scripts or instructions of one or more software programs stored in the communication device 600 (e.g., within memory 640).

The processor 630 may execute PAL control software module 644 to control various operations of PAL unit 620, for example, to provide flow control for data received from, and transmitted to, one or more instances of application software module 647. In some embodiments, execution of PAL control software module 644 may enable PAL unit 620 to receive and/or transmit data based, at least in part, on a communication protocol. For example, execution of PAL control software module 644 may cause communication device 600 to receive and/or transmit data in accordance with an IEEE 802.11, BLUETOOTH, Powerline, Ethernet, or any other technically feasible communication protocol. In some embodiments, PAL control software module 644 may be executed by processor 630 to manage a transfer timer that may be used to control data transfers and/or detect data transfer errors between communication devices.

The processor 630 may execute MAC layer control software module 645 to control various operations of MAC layer unit 615, for example, to access the shared communication medium. For example, execution of MAC layer control software module 645 may cause MAC layer unit 615 to transmit and/or receive communication data through the shared communication medium.

Application software module 647 may include one or more programs that may be executed by a user of communication device 600. For example, the user-executable programs may include communication applications, web browsing applications, file management applications, operating systems, or any other technically feasible programs.

FIG. 7 shows an illustrative flow chart depicting an example operation 700 for transferring data through a shared communication medium, in accordance with example embodiments. Some embodiments may perform the operations described herein with additional operations, fewer operations, operations in a different order, operations in parallel, and/or some operations differently. Referring also to FIGS. 2-4, PAL unit 210 requests information associated with error recovery capabilities from MAC layer unit 220 (704). In some embodiments, the request for error recovery capabilities may be a primitive message, such Request.ErrorRecovery message 402, and may include information associated with TransferTimeout period 316.

Next, PAL unit 210 receives information associated with error recovery capabilities from the MAC layer unit 220 (706). For example, PAL unit 210 may receive information associated with error recovery capabilities through a primitive message, such as Response.ErrorRecovery message 404. In some embodiments, Response.ErrorRecovery message 404 may include information indicating whether error recovery procedures are supported by MAC layer unit 220 and/or a maximum number of data transfer attempts that may be supported by MAC layer unit 220.

Next, PAL unit 210 may cause communication device DEV1 to initiate the data transfer to communication device DEV2 (708). For example, the data transfer may be initiated from communication device DEV1 when TransferReq message 302 is sent from the PAL unit 210 to the MAC layer unit 220. In response to receiving the TransferReq message 302, the MAC layer unit 220 may contend for medium access and, when granted access to the shared communication medium, may transmit data during a corresponding TXOP duration. In some embodiments, when the data transfer is initiated, the transfer timer 211, as controlled by PAL unit 210, may be started. The value of the transfer timer 211 may be based on the TXOP duration. As described above, the transfer timer 211 may be used to detect error conditions associated with a pending data transfer.

Next, PAL unit 210 determines if the value of the transfer timer 211 exceeds the TransferTimeout period 316 (710). If the transfer timer value is greater than the TransferTimeout period 316 (e.g., which may indicate an error condition), the pending data transfer is cancelled (718). In some embodiments, the transfer timer 211 may be reset when the pending data transfer is cancelled. Operations proceed to 708.

If the transfer timer value is less than or equal to TransferTimeout period 316 (as tested in 710), then PAL unit 210 determines if a transfer response message is received from MAC layer unit 220 (712). In some embodiments, the transfer response message may be TransferResp message 308 to indicate that the pending data transfer is complete. If PAL unit 210 receives the transfer response message, then PAL unit 210 waits for the next data transfer (714). In some embodiments, the transfer timer 211 may be reset after the pending data transfer is complete. When the next data transfer is ready, operations proceed to 708.

If PAL unit 210 does not receive the transfer response message from MAC layer unit 220 (as tested at 712), then PAL unit 210 determines if a data transfer status message is received (716). In some embodiments, the data transfer status message may include information associated with the pending data transfer, and may be an Indication.TxStatus message 410. As described above, the Indication.TxStatus message 410 may include a status of the pending data transfer (TxStatus) and an expected duration of the pending data transfer.

If the data transfer status message is not received (as tested at 716), then operations proceed to 710. If the data transfer status message is received, then PAL unit 210 determines if the status of the pending data transfer indicates a failed data transfer (720). If the status of the pending data transfer indicates a failed data transfer, then operations proceed to 718 to cancel the pending data transfer. On the other hand, if the status of the pending data transfer does not indicate a failed data transfer (e.g., which in turn may indicate that the pending data transfer is still in progress), then TransferTimeout period 316 may be extended (724). Thus, to prevent a premature and/or erroneous cancellation of the pending data transfer, TransferTimeout period 316 may be extended based at least in part on the expected duration of the pending data transfer. In this manner, the PAL unit 210 may allow the MAC layer unit 220 additional time to complete the data transfer from communication device DEV1 to communication device DEV2. Operations may proceed to 710.

FIG. 8 shows an illustrative flow chart depicting an example operation 800 for transferring data through a shared communication medium by communication device DEV1, in accordance with example embodiments. Referring also to FIGS. 2, 3, and 5, PAL unit 210 requests MAC information from MAC layer unit 220 (804). In some embodiments, PAL unit 210 may send a primitive message such as Request.MacInformation message 502 to request the MAC information.

Next, PAL unit 210 receives MAC information from MAC layer unit 220 (806). In some embodiments, the MAC information may be included in a Response.MacInformation message 504 received from MAC layer unit 220. MAC information may include the MAC type, the PHY transmission time overhead, the SIFS duration, the slot time, the number of data transfers through which data transfer statistics 508 are collected, and/or contention window information.

Next, data transfers are performed (808). In some embodiments, data may be transferred and data transfer errors may be determined using transfer timer 211 and a TransferTimeout period 316. In some embodiments, as a data transfer between communication device DEV1 and DEV2 begins, a MAC monitoring window may be opened, for example, during which data transfer statistics 508 may be collected. Data transfer statistics 508 may include average data throughput rates and/or an average number of data transfer attempts, each associated with a data packet size.

Next, data transfer statistics 508 are received from MAC layer unit 220 by PAL unit 210 (810). In some embodiments, data transfer statistics 508 collected by MAC layer unit 220 may be transmitted to PAL unit 210 when the MAC monitoring window closes.

Next, the TransferTimeout period 316 is modified based, at least in part, on data transfer statistics 508 (812). In some embodiments, the TransferTimeout period 316 may be extended in accordance with eq.2 expressed above. Operations proceed to 808.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of managing data transfers from a first communication device that includes at least a protocol adaptation layer (PAL) unit and a media access control (MAC) layer unit, the method performed by the first communication device and comprising:
initializing, in the PAL unit, a transfer timer value indicative of a timeout period;
initiating, in the MAC layer unit, a data transfer to a second communication device through a shared communication medium, wherein the data transfer is to be completed within the timeout period; and
selectively modifying, in the PAL unit, the timeout period based, at least in part, on a status of the data transfer.

2. The method of claim 1, wherein the selectively modifying comprises:
sending a status message from the MAC layer unit to the PAL unit, the status message indicating the status of the data transfer;
extending the timeout period if the status message indicates the data transfer is in progress; and
cancelling the data transfer if the status message indicates a failed data transfer.

3. The method of claim 2, wherein the extending the timeout period comprises:
increasing the timeout period based, at least in part, on an expected remaining duration of the data transfer, wherein the status message indicates the expected remaining duration of the data transfer.

4. The method of claim 3, wherein the status message includes a first field to store the status of the data transfer, and includes a second field to store the expected remaining duration of the data transfer.

5. The method of claim 1, further comprising:
selectively cancelling, by the PAL unit, the data transfer prior to an expiration of the timeout period based, at least in part, on the status of the data transfer.

6. The method of claim 1, further comprising:
prior to initiating the data transfer, sending an error recovery capability message from the MAC layer unit to the PAL unit.

7. The method of claim 6, wherein the error recovery capability message indicates whether the MAC layer unit supports sending, to the PAL unit, a status message indicating the status of the data transfer and an expected remaining duration of the data transfer.

8. The method of claim 7, wherein the error recovery capability message is sent in response to receiving an error recovery capability request message from the PAL unit.

9. The method of claim 1, wherein the selectively modifying comprises:
sending a status message from the MAC layer unit to the PAL unit, the status message including data transfer statistics; and
modifying the timeout period based, at least in part, on the data transfer statistics.

10. The method of claim 9, wherein the data transfer statistics include an average data throughput rate and an average number of data transfer attempts associated with a plurality of data packet sizes.

11. The method of claim 9, where the data transfer statistics are collected for a predetermined number of data transfers.

12. A first communication device comprising:
a protocol adaptation layer (PAL) unit to initialize a transfer timer value indicative of a timeout period; and
a media access control (MAC) layer unit to initiate a data transfer to a second communication device through a shared communication medium, wherein the data transfer is to be completed within the timeout period and wherein the PAL unit is to selectively extend the timeout period based, at least in part, on a status of the data transfer.

13. The first communication device of claim 12, wherein the PAL unit is to:
receive a status message from the MAC layer unit, the status message to indicate the status of the data transfer;
extend the timeout period if the status message indicates the data transfer is in progress; and
cancel the data transfer if the status message indicates a failed data transfer.

14. The first communication device of claim 13, wherein the PAL unit is to:
extend the timeout period based, at least in part, on an expected remaining duration of the data transfer, wherein the status message indicates the expected remaining duration of the data transfer.

15. The first communication device of claim 14, wherein the status message includes a first field to store the status of the data transfer, and includes a second field to store the expected remaining duration of the data transfer.

16. The first communication device of claim 12, wherein the PAL unit is to:
selectively cancel the data transfer prior to an expiration of the timeout period based, at least in part, on the status of the data transfer.

17. The first communication device of claim 12, wherein the MAC layer unit is to:
prior to initiating the data transfer, send an error recovery capability message to the PAL unit.

18. The first communication device of claim 17, wherein the error recovery capability message indicates whether the MAC layer unit supports sending, to the PAL unit, a status message indicating a status of the data transfer and an expected duration of the data transfer.

19. A non-transitory computer-readable medium storing instructions that, when executed by one or more processors of a communication device comprising at least a protocol adaptation layer (PAL) unit and a media access control (MAC) layer unit, cause the communication device to:
initialize, in the PAL unit, a transfer timer value indicative of a timeout period;
initiate, in the MAC layer unit, a data transfer to another communication device through a shared communication medium, wherein the data transfer is to be completed within the timeout period; and
selectively modify, in the PAL unit, the timeout period based, at least in part, on a status of the data transfer.

20. The non-transitory computer-readable medium of claim 19, wherein execution of the instructions to selectively modify the timeout period causes the communication device to:
send a status message from the MAC layer unit to the PAL unit, the status message indicating the status of the data transfer;
extend the timeout period if the status message indicates the data transfer is in progress; and
cancel the data transfer if the status message indicates a failed data transfer.
